(19) United States
(12) Patent Application Publication
(10) Pub. No.: US 2003/0098210 A1
(43) Pub. Date: May 29, 2003

(54) Valve spool for suspension damper

(75) Inventors: Troy A. Miller, York, PA (US); Michael L. Oliver, Xenia, OH (US); William C. Kruckemeyer, Beavercreek, OH (US)

Correspondence Address: SCOTT A. MCBAIN, DELPHI TECHNOLOGIES, INC. Legal Staff, 1450 W. Long Lake, P.O. BOX 5052 Mail Code: 482-204-450, Troy, MI, 48098, US

(73) Assignee: DELPHI TECHNOLOGIES INC.

(21) Appl. No.: 09/994,306

(22) Filed: Nov. 26, 2001

(51) Int. Cl. F16F 9/50

(52) U.S. Cl. 188/282.6

(57) ABSTRACT

A valve spool for a suspension damper comprises a body portion and a bridge connected to the body portion. The body portion has an upper edge, and the bridge extends at least partially beyond the upper edge of the body portion.

### TECHNICAL FIELD OF THE INVENTION

The present invention relates to suspension systems for motor vehicles, and more particularly to a valve spool for a suspension damper.

### BACKGROUND OF THE INVENTION

A suspension damper, commonly referred to as a shock absorber, reduces the amplitude of resilient suspension excursions between a sprung mass and an unsprung mass of a motor vehicle by converting into work a fraction of the kinetic energy of the sprung mass. Typically, a suspension damper includes a fluid-filled cylinder tube connected to the unsprung mass, a piston in the cylinder tube connected by a rod to the sprung mass, and valves on the piston which throttle fluid flow across the piston during compression and rebound strokes of the suspension damper attributable to relative suspension excursions between the sprung and unsprung masses. In a twin-tube suspension damper, fluid in the cylinder tube displaced by the connecting rod during a compression stroke of the suspension damper flows through a base valve to an annular reservoir around the cylinder tube and returns through the base valve during a rebound stroke of the suspension damper. In a monotube suspension damper, the volume of a gas chamber at an end of the cylinder tube opposite the connecting rod decreases and increases, respectively, during compression and rebound strokes of the suspension damper as the connecting rod enters and withdraws from the cylinder tube. A twin-tube suspension damper is adapted for pneumatic load leveling by the addition of an expansible chamber between the cylinder tube and the connecting rod which, when inflated with gas at elevated pressure, constitutes a pneumatic spring between the sprung and the unsprung masses. It has been proposed to equip a twin-tube suspension damper adapted for pneumatic load leveling with an external valve which reduces the stiffness of the suspension damper by shunting fluid directly from the cylinder tube to the annular reservoir as the pneumatic pressure in the expansible chamber decreases so that the stiffness of the suspension damper is maximum when the expansible chamber is inflated and minimum when the expansible chamber is exhausted to atmospheric pressure. The external valve, however, increases the size of the suspension damper and may be susceptible to damage from road hazards.

### SUMMARY OF THE INVENTION

The present invention is a valve spool for a suspension damper. The valve spool comprises a body portion and a bridge connected to the body portion. The body portion has an upper edge, and the bridge extends at least partially beyond the upper edge of the body portion.

Accordingly, it is an object of the present invention to provide a valve spool of the type described above which has a raised bridge.

Another object of the present invention is to provide a valve spool of the type described above which reduces flow forces acting on the spool.

Another object of the present invention is to provide a valve spool of the type described above which improves the stability of the spool at various flow rates.

Still another object of the present invention is to provide a suspension damper including a valve spool of the type described above.

These and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a front view of a suspension damper according to the present invention;

FIG. 2 is a cross-sectional view of the suspension damper taken along line 2-2 in FIG. 1;

FIG. 3 is an enlarged view of a portion of the suspension damper; and

FIG. 4 is a perspective view of a valve spool for the suspension damper.

### DETAILED DESCRIPTION OF THE PRESENTLY PREFERRED EMBODIMENTS

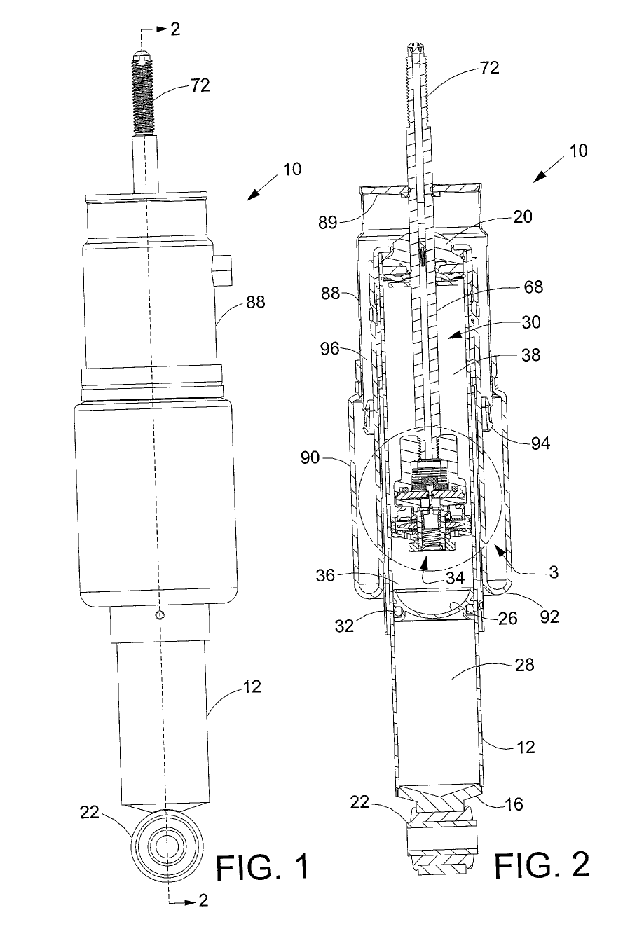

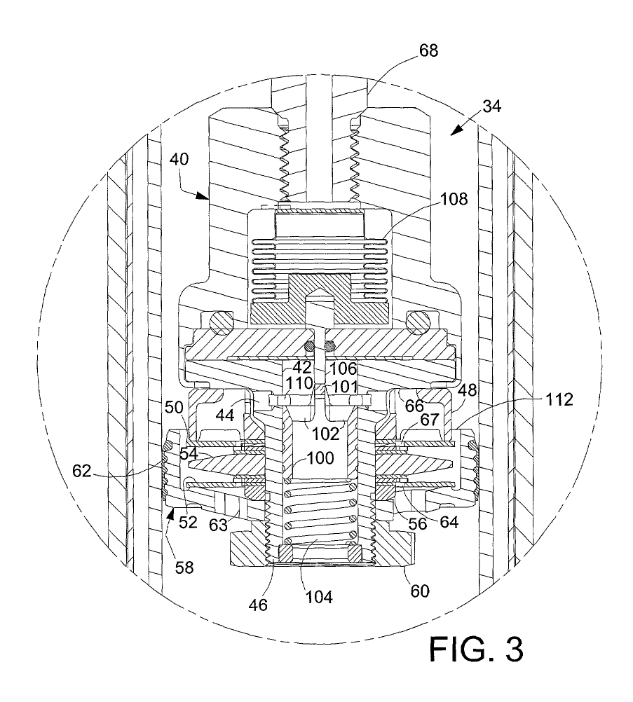

FIGS. 1-3 show one embodiment of a suspension damper 10 according to the present invention for a motor vehicle. The suspension damper 10 includes a cylinder tube 12 sealed closed at one end by a cap 16 and at the other end by a rod guide 20. The cap 16 is welded to the cylinder tube and has a ring 22 thereon which constitutes a lower mount whereat the suspension damper is usually connected to an unsprung mass of the motor vehicle. A gas cup 26 is supported in the cylinder tube 12 for back and forth linear translation and divides the cylinder tube into a gas-filled gas chamber 28 between the cup and the cap 16 and a fluid-filled fluid chamber 30 between the cup and the rod guide 20. A seal 32 on the gas cup prevents leakage between the gas and fluid chambers 28 and 30. A piston 34 is supported in the cylinder tube 12 for back and forth linear translation and divides the fluid chamber 30 into a compression chamber 36 between the piston and the gas cup 26 and a rebound chamber 38 between the piston and the rod guide 20.

The piston 34 includes a piston body 40 having a center bore 42 therethrough, a plurality of lateral bores 44 into the center bore, and an external neck 46. An annular spacer 48 seats on the piston body around the neck 46 thereof. An annular first valve plate 50 and an annular second valve plate 52 are stacked on the piston body around the neck 46 thereof under the annular spacer 48 and separated by a beveled washer 54. A second washer 56 and a valve cup 58 are stacked on the piston body around the neck 46 thereof under the valve plate 52 and retained on the piston body by a nut 60 on an outside screw thread on the neck 46. A seal 62 on the valve cup 58 faces the wall of the cylinder tube 12 and cooperates therewith in minimizing leakage of fluid around the piston between the compression and rebound chambers 36 and 38. The valve cup 58 is perforated by a plurality of large apertures 63. The second valve plate 52 seats on the valve cup over the apertures 63 and is perforated by a plurality of small apertures 64. The first valve plate 50 overlaps a plurality of passages 66 in the annular spacer 48, and is perforated by a plurality of small apertures 67.

A tubular connecting rod 68 is supported in the rod guide 20 for back and forth linear translation. The connecting rod is threadingly attached at an inboard end thereof to the piston body 40 in the center bore 42 for back and forth linear translation as a unit with the piston 34. An outboard end 72 of the connecting rod 68 extends beyond the rod guide 20, and includes external threads that may be attached to an upper mount where the suspension damper 10 is usually connected to a sprung mass of the motor vehicle.

The suspension damper 10 is part of a motor vehicle pneumatic load leveling system and, to that end, further includes a rigid tubular skirt 88 around the cylinder tube attached at one end to a cover plate 89 of the rod end fitting 72. A flexible sleeve 90 is clamped to the skirt 88 over an open end thereof and to the cylinder tube 12 around the rod guide 20. A rolling lobe 92 is defined on the flexible sleeve 90 where it loops from outside of the rigid skirt into the annulus between the rigid skirt and the cylinder tube. The rolling lobe rolls back and forth along the length of the cylinder tube during compression and rebound strokes of the suspension damper. A collar 94 on the rigid skirt guides the flexible sleeve into and out of the annulus between the rigid skirt and the cylinder tube.

The flexible sleeve 90 cooperates with the rigid skirt 88, the rod guide 20, and the rod end fitting 72 in defining an expansible pneumatic chamber 96 between the sprung mass of the motor vehicle connected to the rod end fitting and the unsprung mass of the motor vehicle connected to the cylinder tube. Gas, e.g. air, at elevated pressure is introduced into the expansible chamber 96 through a valve stem on the rigid skirt. Further details of this arrangement are disclosed in U.S. Pat. No. 6,161,662, the disclosure of which is hereby incorporated by reference. When the expansible chamber is inflated, it constitutes a pneumatic spring between the sprung and unsprung masses of the motor vehicle having a stiffness which increases as the pneumatic pressure in the expansible chamber increases.

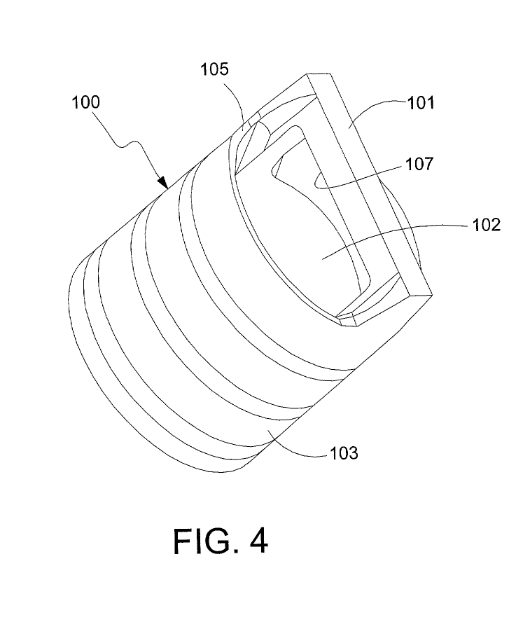

An inverted cup-shaped valve spool 100, shown in perspective view in FIG. 4, is supported in the center bore 42 on the piston body for back and forth linear translation. The valve spool 100 includes a generally cylindrical body portion 103, and a raised bridge 101 spanning an upper edge 105 of the body portion to define a pair of slots 102 on either side of the bridge. In a preferred embodiment, a majority of a lower edge 107 of the bridge is spaced above the upper edge 105 of the body portion. Near its upper edge 105, the inside diameter of the body portion 103 tapers outwardly to increase the cross-sectional area of the slots 102. A spring 104 presses the bridge 101 against the lower end of an actuating pin 106. The actuating pin 106 is movable by any electrical or other suitable actuating device such as metallic bellows 108, and moves the spool 100 against the force of the spring 104. In an open position of the valve spool 100 as shown, the slots 102 register with apertures 110 in the wall of the cylinder 42. The spring 104 biases the valve spool toward a closed position. In the closed position of the valve spool, the slots 102 are separated longitudinally from the apertures 110 so that the latter are blocked by the side of the valve spool.

A primary fluid flow path across the piston 34 includes the large apertures 63 in the valve cup 58 and an annular clearance 112 between the valve cup and the annular spacer 48. During a compression stroke of the suspension damper 10, fluid flows through the primary flow path from the compression chamber 36 to the rebound chamber 38, and is restricted by the pressure gradient across the second valve plate 52 and induces flexure thereof off of the valve cup. During a rebound stroke of the suspension damper, fluid flow through the primary flow path from the rebound chamber 38 to the compression chamber 36 is substantially obstructed by the pressure gradient across the second valve plate 52 and induces flexure thereof near apertures 64. Limited fluid flow is permitted during compression and rebound strokes through the restricted passage 64.

A secondary fluid flow path across the piston 34 includes the center bore 42, the apertures 110, the lateral bores 44, the passages 66 in the annular spacer 48, and the annular gap 106 between the valve cup and the annular spacer. The raised spool bridge 101 significantly reduces the flow forces acting on the spool, thereby improving the spool stability to various flow rates. During a compression stroke of the suspension damper 10 with the valve spool 100 in its open position, fluid flows through the secondary flow path from the compression chamber to the rebound chamber, and is restricted by the pressure gradient across the first valve plate 50 and induces flexure thereof further away from the annular spacer 48. During a rebound stroke of the suspension damper with the valve spool in its open position, fluid flow through the secondary flow path from the rebound chamber to the compression chamber is substantially obstructed by the pressure gradient across the first valve plate 50 and induces flexure thereof near apertures 67. Limited fluid flow is permitted during compression and rebound strokes through the restricted passage 67. When the valve spool 100 is in its closed position, not shown, fluid flow through the secondary flow path is blocked during both compression and rebound strokes of the suspension damper.

In operation, when the load on the sprung mass of the motor vehicle is in a range in which load leveling is not required, the expansible chamber 96 is exhausted to atmospheric pressure. In that circumstance, the spring seats the reaction plate of the diaphragm against the end of the diaphragm chamber and the valve spool 100 is retained in its open position against the bias of the spring 104 so that the secondary fluid flow path is unblocked. Accordingly, during both compression and rebound strokes of the suspension damper, fluid flows through both of the primary and the secondary fluid flow paths with less significant throttling during the compression stroke and more significant throttling during the rebound stroke so that the suspension damper is stiffer during the rebound stroke than during the compression stroke.

When the load on the sprung mass of the motor vehicle is in a range in which load leveling is required, gas at elevated pressure is introduced into the expansible chamber 96 through the valve stem and reacts against the diaphragm through the passages in the cover plate 89. The corresponding pressure gradient across the diaphragm flexes the diaphragm and lifts the reaction plate from the end of the diaphragm chamber until the reaction plate seats on the stop. As pneumatic pressure in the expansible chamber 96 increases, the valve spool 100 translates linearly from its open position to its closed position.

During compression and rebound strokes of the suspension damper 10 with the valve spool 100 in its closed position, fluid flows back and forth through the primary fluid flow path as described above. Fluid flow through the secondary fluid flow path, however, is completely blocked by the valve spool 100 which covers the apertures 110. The total fluid flow across the piston which was divided between the primary and secondary flow paths when the valve spool was in its open position is now forced through only the primary flow path. The pressure gradient across the small apertures 64 in the second valve plate 52 during a rebound stroke of the suspension damper, therefore, increases so that the suspension damper is relatively more stiff with the valve spool in its closed position than with the valve spool in its open position.

When the load on the sprung mass of the motor vehicle is reduced and load leveling is not required, the pneumatic pressure in the expansible chamber 96 is exhausted to atmospheric pressure. The spring then reseats the reaction plate of the diaphragm on the end of the diaphragm chamber and the valve spool 100 returns to its open position so that the total fluid flow across the piston 34 is again divided between the primary and secondary fluid flow paths. The suspension damper 10, therefore, responds to increasing pneumatic pressure in the expansible load leveling chamber 96 by becoming relatively more stiff and to decreasing pneumatic pressure in the expansible load leveling chamber by becoming less stiff.

When a partial load on the sprung mass of the motor vehicle requires an intermediate amount of pneumatic pressure for load leveling, the diaphragm 108 flexes to intermediate positions corresponding to the pressure. This results in the valve spool 100 being translated to locations resulting in partial blocking of the apertures 110, and restricted flow in the secondary flow path. This restriction in the secondary flow path provides damper performance that is adjusted to all normal load variation in the motor vehicle.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A valve spool for a suspension damper, the valve spool comprising:
a body portion having an upper edge; and
a bridge connected to the body portion, the bridge extending at least partially beyond the upper edge of the body portion.

2. The valve spool of claim 1 wherein the bridge has a lower edge, and the lower edge extends at least partially beyond the upper edge of the body portion.

3. The valve spool of claim 1 wherein the bridge has a lower edge, and a majority of the lower edge extends at least partially beyond the upper edge of the body portion.

4. The valve spool of claim 1 wherein the body portion is generally cylindrical.

5. The valve spool of claim 1 wherein the bridge defines at least one slot.

6. A valve for a suspension damper, the valve comprising:
a valve spool movable in a bore, the valve spool including a body portion having an upper edge and a bridge connected to the body portion and extending at least partially beyond the upper edge of the body portion; and
an actuating pin in contact with the bridge to move the valve spool between an open position and a closed position.

7. The valve of claim 6 wherein the bridge has a lower edge, and the lower edge extends at least partially beyond the upper edge of the body portion.

8. The valve of claim 6 wherein the bridge has a lower edge, and a majority of the lower edge extends at least partially beyond the upper edge of the body portion.

9. The valve of claim 6 wherein the body portion is generally cylindrical.

10. The valve of claim 6 wherein the bridge defines at least one slot.

11. The valve of claim 6 wherein the bridge defines at least one slot adapted to register with an aperture in the bore.

12. The valve of claim 6 further comprising a spring adapted to bias the valve spool to a closed position.

13. A suspension damper for a motor vehicle, the suspension damper comprising:
a cylinder tube having a gas cup therein dividing the cylinder tube into a gas-filled gas chamber and a fluid-filled fluid chamber;
a piston supported in the cylinder tube for back and forth linear translation and dividing the fluid chamber into a compression chamber facing the gas cup and a rebound chamber on the opposite side of the piston from the compression chamber; and
a valve including a valve spool movable in a bore in the piston, the valve spool having a body portion with an upper edge and a bridge connected to the body portion and extending at least partially beyond the upper edge of the body portion, and an actuating pin in contact with the bridge to move the valve spool between an open position and a closed position.

14. The suspension damper of claim 13 wherein the bridge has a lower edge, and the lower edge extends at least partially beyond the upper edge of the body portion.

15. The suspension damper of claim 13 wherein the bridge has a lower edge, and a majority of the lower edge extends at least partially beyond the upper edge of the body portion.

16. The suspension damper of claim 13 wherein the body portion is generally cylindrical.

17. The suspension damper of claim 13 wherein the bridge defines at least one slot.

18. The suspension damper of claim 13 wherein the bridge defines at least one slot adapted to register with an aperture in the bore.

19. The suspension damper of claim 13 further comprising a spring adapted to bias the valve spool to a closed position.
